(19) United States
(12) Patent Application Publication
(10) Pub. No.: US 2018/0263222 A1
(43) Pub. Date: Sep. 20, 2018

(54) OXYLIC ACID VAPORIZER

(71) Applicant: William OSTER, Monsey, NY (US)

(72) Inventor: William OSTER, Monsey, NY (US)

(21) Appl. No.: 15/461,670

(22) Filed: Mar. 17, 2017

(51) Int. Cl. A01K 51/00; A01M 13/00; B05B 7/00; B05B 7/22; A01N 37/02

(52) U.S. Cl. CPC A01K 51/00; A01M 13/00; A01N 37/02; B05B 7/22; B05B 7/0081

(57) ABSTRACT

Described herein is an apparatus for dispensing a substance. The apparatus comprises a fan, a wind tunnel, a heating coil, a receptacle, and a container. The fan is adapted to create an air flow in a particular direction. The wind tunnel has a proximate end and a distal end, and is connected to the fan to receive the air flow in the proximate end and channel the air flow towards the distal end. The heating coil is disposed inside the wind tunnel configured to generate heat. The receptacle is to the wind tunnel. The receptacle has an intake hole, an access hole, a discharge hole, and a heating chamber. The heating chamber connects the intake hole, access hole, and the discharge hole. The container is disposed in the heating chamber and has an opening. The cover covers the access hole. The receptacle receives the air flow from the proximate end of the wind tunnel and channels the air flow from the intake hole around the container to the discharge hole. Additionally, the heating chamber is heated with the heat from the heating coil.

### BACKGROUND

Honey bees are used to make various products such as wax and honey. Over 150 million pounds of honey are produced every year.

Honey bees make honey by collecting nectar from flowers that mixes with an enzyme that is found in the honey bee's mouth. Honey bee's deposit the nectar, mixed with the enzyme, in a bee hive or nest.

A bee hive can either be a natural colony made by the honey bees or a man-made artificial structure used as a colony (artificial bee hive). Bee hives include honeycombs that are made by honey bees using wax. An artificial bee hives typically include parallel shelf-like structures known as frames. Honey bees form the honeycombs on the frames. Honeycombs work like cells for storing the nectar/enzyme mixture. The nectar/enzyme mixture becomes thicker as the water content is reduced, either by dissipation or evaporation (down to approximately 17%), resulting in honey. When the honeycomb is filled with honey, the honey bees cap the honeycomb. In an artificial bee hive, when all of the honeycombs are capped, a beekeeper can extract the honey by removing each frame, and cutting off the caps from the honeycombs.

Varroa mites are a very destructive pest to honeybees that arrived in the United States in the mid-1980's. Varroa mites are parasites that suck blood from honey bees and destroy their larvae. If left untreated, even a low-level infestation of varroa mites can destroy an entire honey bee colony.

Further limitations and disadvantages of convention and traditional approaches will become apparent to one of skill in the art, through comparison of such systems with embodiments of the present invention as set forth in the remainder of the present application with reference to the drawings.

### SUMMARY

Described herein is an apparatus for dispensing a substance. The apparatus comprises a fan, a wind tunnel, a heating coil, a receptacle, and a container. The fan is adapted to create an air flow in a particular direction. The wind tunnel has a proximate end and a distal end, and is connected to the fan to receive the air flow in the proximate end and channel the air flow towards the distal end. The heating coil is disposed inside the wind tunnel configured to generate heat. The receptacle is to the wind tunnel. The receptacle has an intake hole, an access hole, a discharge hole, and a heating chamber. The heating chamber connects the intake hole, access hole, and the discharge hole. The container is disposed in the heating chamber and has an opening. The cover covers the access hole. The receptacle receives the air flow from the proximate end of the wind tunnel and channels the air flow from the intake hole around the container to the discharge hole. Additionally, the heating chamber is heated with the heat from the heating coil.

In another embodiment, an apparatus for dispensing a substance comprises a housing, a fan, a heating coil, and a container. The housing defines a cavity, the housing having a rear, a front end portion and a top side. The fan is connected to the rear of the housing. The heating coil disposed in the housing in front of the fan. The container has an opening into the cavity, and is disposed in front of the heating coil. The housing further comprises an opening at the front end portion, a hole substantially proximate to the container and a cap detachably connected to the housing, covering the hole when connected to the housing.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a vaporizer;

FIG. 2A is a side view of an oxalic acid vaporizer;

FIG. 2B is a top view of an oxalic acid vaporizer;

FIG. 3A is an exploded view of the receptacle;

FIG. 3B is a side view of the receptacle; and

FIG. 3C is a top view of the receptacle;

### DETAILED DESCRIPTION

The following description describes certain embodiments. The following discussion shall be understood to be only for the purpose of enabling a person of ordinary skill in the art to make and use the subject matter of any claims that are presently pending or may later be added, or which may issue in any patent. It shall be understood that the following embodiments are not limiting and nothing is essential or critical unless specifically designated.

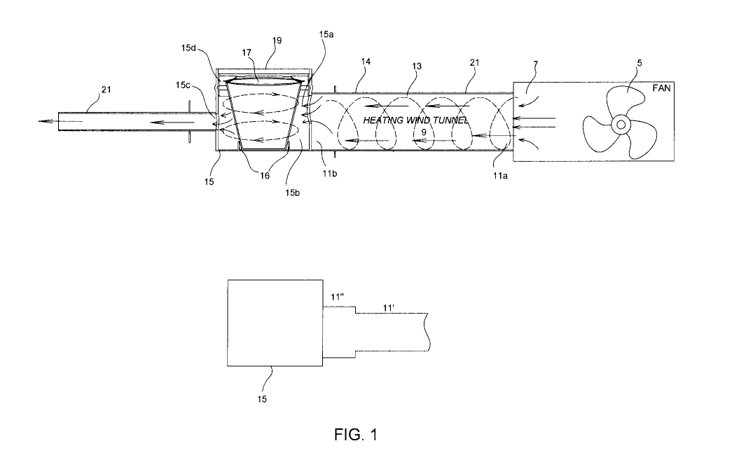

Referring now to FIG. 1, there is illustrated a block diagram of a vaporizer 1. The vaporizer 1 comprises a fan 5. When the fan 5 is turned on, the fan 5 creates an air flow 7 in a particular direction. A heating wind tunnel 9 is connected to the fan 5. As used in this i document, “connected”, such as “A is connected to B”, shall be interpreted by its plain and ordinary meaning, and to further include the circumstance where A is integrally formed with B, A is welded to B, A is fixed by adhesive to B, or A is fixed by sealing material to B, and shall further include where A is connected via C to B.

In one embodiment, the heating wind tunnel 9 can comprise a wind tunnel 11 with a heating coil disposed 13 disposed therein. The wind tunnel 11 receives the air flow 7 in the proximate end 11a and channels the air flow to the distal end 11b. Additionally, the heating coil 13 heats an area near the distal end 11b. The wind tunnel 11 can comprise a pipe or series of pipes substantially air-tightly connected in the direction of the air flow 7. For example, in one embodiment, the wind tunnel 11 can be formed by a pipe section 11′ slid over by a pipe section 11″ that is connected, welded to, or integrally formed with receptacle 15, or vice versa.

The distal end 11b of the wind tunnel 11 can be connected to a receptacle 15. The receptacle 15 includes an intake hole 15a, a heating chamber 15b, a discharge hole 15c, and an access hole 15d. The heating chamber 15b connects the intake hole 15a, the discharge hole 15c, and the access hole 15d.

The heating chamber 15b includes a container 17 disposed therein. The container 17 can be inserted and removed from the heating chamber 15b via the access hole 15d. The access hole 15d is covered by a cover 19. The cover 19 can be detachably connected to the receptacle 15 to cover the access hole 15d. The cover can be detachably connected in a variety of ways including, but not limited to engagement of screw threads, lateral pressure between the edges of the cover 19 and a structure surrounding the access hole 15d, a hinge connection on one side and stopper, or another structure affixed over the cover. In certain embodiments, the cover 19 can be a laterally slidable door.

The cover 19 can be positioned to be proximate to the heating chamber 15b. For example, the range of distance of the access hole 15d and cover 19 from nearest to farthest along the longitudinal axis can be within the range of distance of the heating chamber 15b along the longitudinal axis.

In certain embodiments, the heating chamber 15b can include a structure(s) 16 for removably connecting the container 17. For example, the structure 16 can apply lateral pressure against the base of the container 17. In some embodiments, the distance of the structure 16 from nearest to farthest along the longitudinal axis can be within the range of the distance of the access hole 15d.

The receptacle 15 can be connected to the distal end 11b of the wind tunnel 11 to receive the air flow and adapted to channel the air flow from the intake hole 15a, through the heating chamber 15b, around the container 17, to the discharge hole 15c. In some embodiments, the air flow is channeled to flow over the container 17. Connection of the receptacle 15 to the distal end 11b of the wind tunnel 11 can heat the heating chamber 15b with the heating coil 13. In certain embodiments, heating coil 13 can generate enough heat to cause the heating chamber 15b to attain at least a temperature that is known to vaporize the substance. Furthermore, the heating coil 13 can be controlled to generate heat causing the heating chamber 15b to attain and maintain a temperature in a range between a threshold above a temperature known to vaporized the substance, and below another threshold below another temperature known to break down, or burn the substance.

Placement of heating chamber 15b and container 17 therein separated, or outside of the heating coils allows the user to remove and insert the container 17 without exposure to the heating coils 13, through access hole 15d.

The container 17 is configured to store and restrict the motion of a substance while the substance is in a non-vaporized form. In some embodiments, the heating coil 13 can heat the heating chamber 15b causing a substance in the container 17 to vaporize. Container 17 can include an opening 17′ allowing the substance in vaporized form to escape into the remainder of the heating chamber 15b. The air flow around the container 17 forces the vaporized substance that escapes from the container to the discharge hole 15c.

In certain embodiments, the discharge hole 15c can be connected to a dispensing pipe structure 21. The dispensing pipe structure 21 can further control dispensing of the vaporized substance for various purposes. In some embodiments, it may be desirable for the heating wind tunnel 9 to be wide to allow faster heating of the heating chamber 15b. It may also be desirable to introduce the vapor through a small hole in a targeted structure. Accordingly, in such uses, the dispensing pipe structure 21 can have a narrow width to allow the dispensing pipe structure 21 to be inserted into the small hole in the target structure.

The wind tunnel 11 and receptacle 15 can form a housing. The housing can define a cavity comprising the interior of the wind tunnel 11 from the proximate end 11a to the distal end 11b, and the heating chamber 15b. Additionally, the wind tunnel 11, receptacle 15 and dispensing pipe structure 21 can also form a housing, while the cavity comprises the interior of the wind tunnel 11 from the proximate end 11a to the distal end 11b, the heating chamber 15b and the interior of the dispensing pipe structure 21. The fan 5 can be connected to the rear of the either of the foregoing housings. The discharge hole 15c or an opening in the dispensing pipe structure 21 can be considered the front portion of the housing. The heating coil 13 and the container 17 can be disposed in the cavity. The container 17 can be disposed in the cavity, detachably connected to the bottom portion of the housing.

The vaporizer 1 can be used to dispense a variety of vaporized substances for a wide variety of uses. For example, the vaporizer 1 can be used to treat a honey bee colony of pests such as varroa mites. Oxalic acid is a crystalline solid that can be used to destroy or significantly reduce varroa mites. When used in low enough concentrations (0.55 g/cubic ft, 20 g/cubic meter), oxalic acid does not affect honey bees, their larvae, the honey product, or hive structure.

In one embodiment, presented herein, an apparatus distributes the oxalic acid into the bee hive. In certain embodiments, the apparatus distributes the oxalic acid into the bee hive relatively uniformly, avoiding excessive concentration in certain areas and ineffective concentration in other areas. For example, the vaporizer 1 can vaporize the oxalic acid with the heating coil 13 and blow the vaporized oxalic acid with the fan 5. The heating coil 13 can be controlled to heat the heating chamber to a predetermined threshold value above 315° F./157.2° C. at which oxalic acid crystals transform from a solid to a gas and another predetermined threshold value below 372° F./189° C., at which oxalic acid crystals breaks down into formic acid and carbon monoxide.

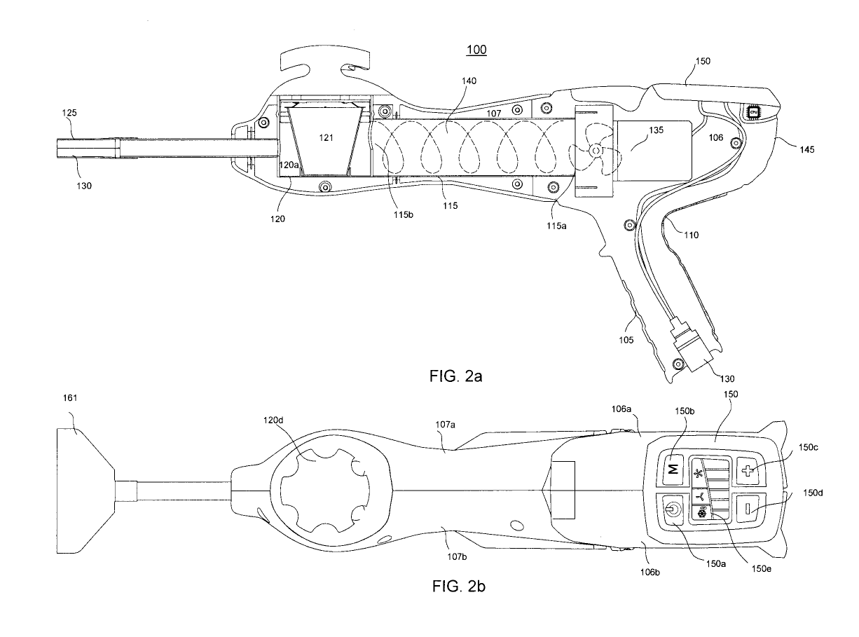

Referring now to FIG. 2, there is illustrates a block diagram of an external side view (FIG. 2A) and top view (FIG. 2B) of an oxalic acid vaporizer 100 in accordance with one embodiment of the disclosure. The oxalic acid vaporizer 100 includes a grip 105, a stock 110, a fan 135, a wind tunnel 115, a receptacle 120, and a dispensing pipe structure 125.

A covering portion 106 formed of two halves 106a, 106b fused or screwed together can form the grip 105 and stock 110. The grip is configured to be held by the user's closed fist. Covering portion 107 can be formed of two halves 107a, 107b fused or screwed together to position and support the fan 135, wind tunnel 115, the receptacle 120, and at least a portion of the dispensing pipe structure 125.

It is noted that the wind tunnel 115, receptacle 120, and dispensing pipe structure 125 can attain temperatures exceeding 300° F./148° C. Accordingly, covering portion 107 can comprise materials that can withstand such temperatures, and are sufficiently non-conductive to prevent burning the user's hand. Alternatively, the covering portion 106 and 107 can be a single covering. In certain embodiments, the covering portions 106, and 107 can include plastics such as a polyamide-imide.

In certain embodiments, the wind tunnel 115, receptacle 120, and dispensing pipe structure 125, can comprise aluminum or stainless steel, or a combination thereof.

The fan 135 is adapted to provide an air flow in the direction towards the heating wind tunnel 115. The wind tunnel 115 channels the air flow from a proximate end 115 a to a distal end 115b. Additionally, the wind tunnel 115 includes a heating coil 140 disposed therein. The wind tunnel 115 provides the air flow and the heating coil 140 provides heat to the receptacle 120. The receptacle 120 stores oxalic acid crystals. The heat causes the oxalic acid in the receptacle 120 to vaporize. The air flow forces the vaporized oxalic acid into the dispensing pipe structure 125. The dispensing pipe structure 125 transfers the vaporized oxalic acid to the opening 131. The opening 131 discharges the vaporized oxalic acid out of the oxalic acid vaporizer 100. A user can position the opening directly at or into an opening in a bee hive, thereby distributing the vaporized oxalic acid into the bee hive. In certain embodiments, the dispensing pipe structure 125 can be fitted with additional piping 161 depending on use.

The stock 110 secures the proximate end 115 a of the wind tunnel 115, a power supply 130, the fan 135, one or more processors 145, and a control panel 150. In certain embodiments, the power supply 130 can include, but is not limited to a battery or a transformer connected to a plug for an external power outlet.

The power supply provides power to the fan 135, the heating coil 140 and the one or more processors 145. In a manner that will be further explained below, the one or more processors 145 control the fan 135 and the heating coil 140. The control panel 150 provides a user interface to the one or more processors 145, allowing the user to control the fan 135 and the heating coil 140. The heating coil 140 is regulated to provide sufficient heat to vaporize oxalic acid, but avoid excessive heat that will cause the oxalic acid to break down into formic acid and carbon monoxide. In one embodiment, the heating coil 140 is set at default temperature that results in a temperature of between 315° F./157.2° C. to 372° F./189° C. at the receptacle 120. In another embodiment, the user can enter a desired temperature to attain at the receptacle 120 using the control panel 150. In another embodiment, a feedback loop including a temperature sensor disposed near or in the receptacle 120 is used to regulate the heating coil to result in a temperature of between 315° F./157.2° C. to 372° F./189° C. at the receptacle 120.

The control panel 150 is on a top surface of the stock 110. The control panel 150 can include an on/off button 150a, a mode button 150b, and increase and decrease buttons 150c and 150d. Additionally, the control panel 150 can also include a display 150e which indicates the fan speed, and the temperature applied to the oxalic acid, and the amount of crystallized oxalic acid in the receptacle. The mode button 150b allows the user to select between controlling and displaying the temperature, fan speed, and amount of non-vaporized oxalic acid in the receptacle. The increase and decrease buttons 150c and 150d allow the user to set the desired fan speed or temperature to maintain at the receptacle. The display 150e can be a light emitting diode (LED) display or plasma display. During one mode where the user sets the temperature, the display 150e can display the presently set temperature, allowing the user to use the increase and decrease buttons 150c and 150d to incrementally (such as +/−5° F./2.77° C. per increment) set the desired temperature. During another mode, the display 150e displays the temperature at the receptacle 120 and the amount of crystalline oxalic acid remaining in the receptacle 120. In certain embodiments, the entire control panel 150 can be a touch screen, where buttons 150a, 150b, 150c, and 150d are virtual buttons.

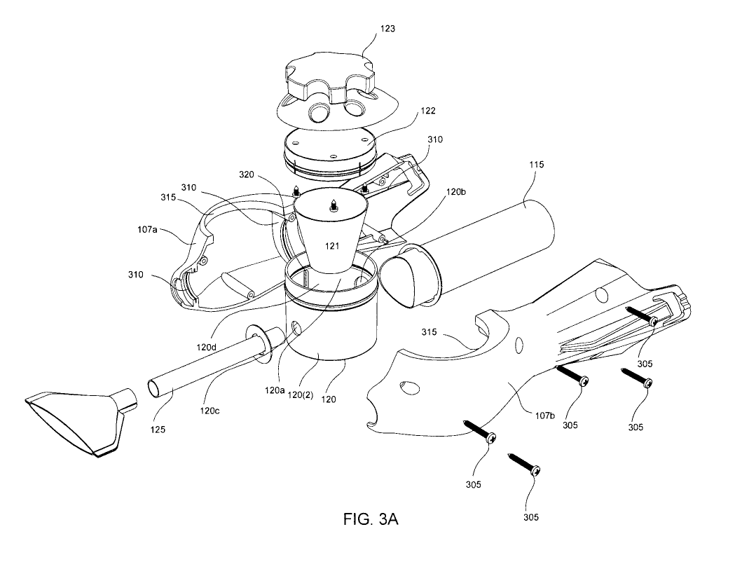

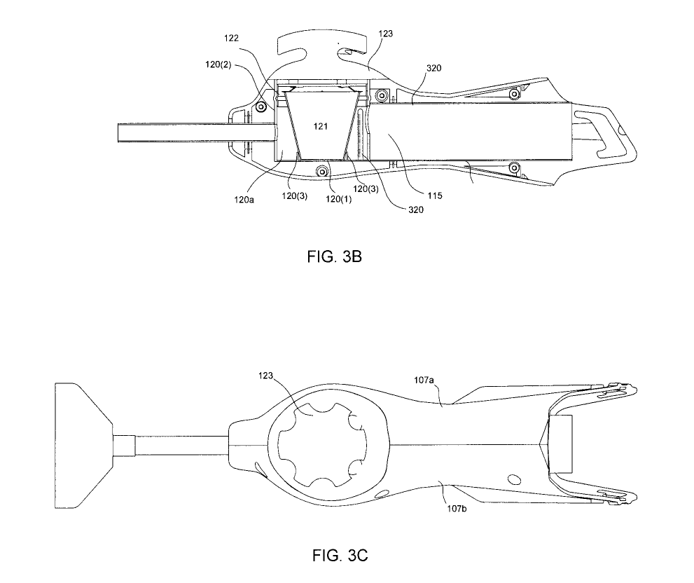

The distal end 115b of the wind tunnel 115 is connected to the receptacle 120. The receptacle 120, which will be described in more detail in FIGS. 3A-3C, can include a substantially cylindrically shaped jar 120. The jar 120 forms a heating chamber 120a. The heating chamber 120a can further have a container 121 disposed therein. The volume of the container 121 is less than the volume of the heating chamber 120a, thereby resulting in an open space in the heating chamber 120a. The container 121 stores the oxalic acid in the crystalline form. The heat from the heating coil 140 heats the heating chamber causing the oxalic acid in the container 121 to vaporize. The vaporized oxalic acid escapes from the container 121 and enters the remaining portion of the heating chamber 120a.

The air flow from the distal end of the wind tunnel forces the vaporized oxalic acid into the dispensing piping structure 125. The dispensing piping structure 125 can have substantially the same axis as the wind tunnel 115. In certain embodiments, the dispensing piping structure 125 has a smaller diameter than the wind tunnel 115. The smaller diameter causes the vaporized oxalic acid flow through the discharge piping structure faster. The faster speed allows the user to have greater control of the direction that the vaporized oxalic acid, and allows the vaporized oxalic acid to disperse faster into the bee hive. The vaporized oxalic acid may cool quickly after being ejected and recrystallize. However, with a higher ejection speed, the vaporized oxalic acid will spread about more of the bee hive before recrystallizing.

The wind tunnel 115 can comprise a pipe or series of pipes substantially air-tightly connected in the direction of the air flow. For example, wind tunnel 115 can include a pipe integrally formed with the fan 135 and another pipe welded to the receptacle 120, wherein pipe welded to the receptacle 120 is slidably connected over the pipe integrally formed over the fan, such that pipe integrally formed over the fan provides sufficient outward pressure against the pipe welded to the receptacle 120 forming an air-tight or substantially air-tight seal, or vice versa.

Referring now to FIGS. 3A-3C, there is illustrated an exploded view, FIG. 3A, side view FIG. 3B, and top view FIG. 3C of the jar 120. The jar 120 includes a heating chamber 120a, intake hole 120b, a discharge hole 120c, and access hole 120d. The intake hole 120b, discharge hole 120c, and access hole 120d are connected by the heating chamber 120a. The wind tunnel 115 is connected to the receptacle 120 to provide air flow through intake hole 120b. Receptacle 120 channels the air flow received from intake hole 120b around and over the container 121 in the heating chamber 120a to discharge hole 120c. The discharge hole 120c is connected to a discharge piping structure 125. The axis of the wind tunnel 115 and the axis of the discharge piping structure 125 can be substantially the same. Alternatively, the axis of the discharge piping structure 125 can be substantially parallel to the axis of the wind tunnel 115, such that the axis of the discharge piping structure 125 extends through the interior of the wind tunnel 115. The axis of the jar 120 can be substantially orthogonal to the axis of the wind tunnel 115 and the axis of the discharge piping structure 125.

The jar 120 includes a base 120(1), and a substantially circular wall 120(2). Wall 120(2) and an intake hole 120b correspond to the circumference of the wind tunnel 115, such that wind tunnel 115 can form an air-tight connection with receptacle 120 (by either welding, adhesive, or elastic seal), allowing air to transfer from the wind tunnel 115 to the receptacle 120. In certain embodiments, the wind tunnel 115 and the jar 120 can be integrally formed. Integral formation of the wind tunnel 115 and the jar 120 can be advantageous over connection of the wind tunnel 115 and the receptacle 120 because the points of connection may be less susceptible to wear and tear.

The jar 120 has discharge hole 120c corresponding to the circumference of the discharge piping structure 125. Hole 120c corresponds to the circumference such that discharge piping structure 125 can form an air-tight connection with jar 120 (by either welding, adhesive, or elastic seal), allowing air to transfer from the jar 120 to the discharge piping structure 125. In certain embodiments, the discharge piping structure 125 and the jar 120 can be integrally formed. Integral formation of the discharge piping structure 125 and the receptacle 120 can be advantageous because over connection of the discharge piping structure 125 and the jar 120 because the points of connection may be less susceptible to wear and tear.

The jar 120 can have a container 121 disposed inside the heating chamber 120a. The container can include, among other things, a cup. The container 121 is configured to be filled with oxalic acid in crystalline form. The container 121 can have a height that is less than the height of the wall 120(2) to allow vaporizing oxalic acid to enter the remaining area of the heating chamber 120a. In some embodiments, the jar 120 can include a circular groove 120(3) configured to provide lateral support for the container 121. In some embodiments, the height of the container 121 can be less than but close to the height of the wall 120(2) to restrict spillage of the oxalic acid in crystalline form, when the container 121 is not oriented to be fully vertical.

In one embodiment, the base of the jar 120(1) can include a weight sensor that measures the weight under the container 121. The weight sensor can provide the weight under the container 121 to the processor 145. The processor 145 can subtract the known empty weight of the container 121, thereby resulting in amount of the oxalic acid in crystalline form. The processor 145 can cause the control panel 150 to display the amount of the remaining oxalic acid in crystalline form in the container 121.

The cover 122 is detachably connectable to the wall 120(2) to cover access hole 120d. In certain embodiments, the cover 122 can be screwed onto the top of the wall 120(2). In another embodiment, a cap 123 can screwed into the cover portion 107 by twisting a handle. When the cap 123 is screwed into the cover portion 107, the cap 123 provides downward pressure against cover 122, securing the cover 122 over the wall 120(2) of the jar 120, thereby covering the access hole 120d. In certain embodiments, when the cover 122 is connected to the wall 120(2), the cover 122 and the wall 120(2) form an airtight seal.

The cap 123, and cover 122 can be removed, allowing access to the container 121. The container 121 can be removed from the jar 120 and used as a measuring cup to retrieve a predetermined amount of crystalline oxalic acid from a larger supply.

The cover portion 107 can include halves 107a and 107b screwed together by screws 305. In certain embodiments, the halves 107a and 107b can include fixings that surround the wind tunnel 115 and discharge piping structure 125. Additionally, cover portion 107 can include semicircular openings 315 that form a substantially circular opening over jar 120. The openings 315 can facilitate attachment of cap 123.

In some embodiments, the receptacle 120 can include a sensor 320, such as a thermometer, that measures the temperature at the receptacle 120. The sensor 320 can provide the measured temperature to the processor 145, which causes the control panel 150 to display the temperature. Additionally, the processor 145 can use the temperature provided by the sensor 320 to control the heating coil 140. For example, if the temperature is below 315° F./157° C., the processor 145 can cause the heating coil 140 to provide more heat, and if the temperature approaches 372° F./189° C., can cause the heating coil 140 to provide less heat.

While it should be understood that the foregoing is not limiting, in one embodiment, various components can have the following dimensions:

| Component | Measurement - Inches | Metric Units - mm |
|---|---|---|
| Length of Wind Tunnel 115 | 5½ | 139.7 |
| Width of Wind Tunnel 115 | 1 19/32 | 40.23 |
| Height of Jar 120 | 2 7/32 | 56.43 |
| Diameter of Jar 120 | 2⅝ | 67.9 |
| Height of Cup 121 | 1 27/32 | 47.11 |
| Volume of Cup 121 | 1.84 oz | 54.46 ml |
| Length of Discharge Piping | 4¼ | 107.87 |
| Structure 125 | | |
| Width of Discharge Piping | ½ | 12.7 |
| Structure 125 | | |

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for dispensing a substance, the apparatus comprising:
a fan adapted to create an air flow in a particular direction;
a wind tunnel having a proximate end and a distal end, connected to the fan to receive the air flow in the proximate end and channel the air flow towards the distal end;
a heating coil disposed inside the wind tunnel configured to generate heat;
a receptacle connected to the wind tunnel having an intake hole, an access hole, a discharge hole, and a heating chamber, wherein the heating chamber connects the intake hole, access hole, and the discharge hole;
a container disposed in the heating chamber with an opening; and
a cover covering the access hole;
wherein the receptacle is connected to the wind tunnel to:
receive the air flow from the proximate end of the wind tunnel and channel the air flow from the intake hole around the container to the discharge hole; and
heat the heating chamber with the heat from the heating coil.

2. The apparatus of claim 1, wherein the receptacle and the wind tunnel are integrally formed.

3. The apparatus of claim 1, wherein the container is adapted to receive the substance and restrict motion of the substance in a non-vaporized form.

4. The apparatus of claim 3, wherein the heating coil is configured to heat the substance into a vaporized form, and wherein the air flow channels the substance in the vaporized form to the discharge hole.

5. The apparatus of claim 1, wherein the container is adapted to receive oxalic acid.

6. The apparatus of claim 5, wherein the heating coil is adapted to heat the oxalic acid to a temperature between a predetermined threshold above 315° F./157.2° C. and another predetermined threshold below 372° F./189° C.

7. The apparatus of claim 1, wherein the discharge hole of the receptacle is connected to a dispensing pipe structure, wherein the wind tunnel is wider than the dispensing pipe structure.

8. The apparatus of claim 1, wherein the wind tunnel comprises a first pipe connected over a second pipe.

9. The apparatus of claim 1, wherein a circular groove laterally supporting the container is disposed in the heating chamber.

10. The apparatus of claim 9, wherein a range of the distance of the circular groove along a longitudinal axis is within a range of the distance of the cover along the longitudinal axis.

11. An apparatus for dispensing a substance, said apparatus comprising:
a housing defining a cavity, the housing having a rear, and a front end portion;
a fan connected to the rear of the housing;
a heating coil disposed in the housing in front of the fan;
a container with an opening into the cavity, the container disposed in front of the heating coil; and
wherein the housing further comprises:
an opening at the front end portion;
a hole substantially proximate to the container; and
a cap detachably connected to the housing, covering the hole when connected to the housing.

12. The apparatus of claim 11, wherein the rear end portion of the housing comprises a wind tunnel having a first width, wherein the heating coil is disposed in the wind tunnel.

13. The apparatus of claim 12, wherein the front end portion of the housing comprises a dispensing pipe structure having a second width, the second width less than the first width.

14. The apparatus of claim 11, wherein the housing has a bottom portion and the container is removably connected to the bottom portion of the housing, wherein the container is configured to be removed from the housing through the hole.

15. The apparatus of claim 11, wherein the container is configured to hold the substance and restrict motion of the substance while the substance is in a non-vaporized form, and permit the substance to escape from the container into the cavity in the vaporized form.

16. The apparatus of claim 15, wherein the heating coil is configured to heat the substance in the non-vaporized form, thereby causing the substance to enter the vaporized form.

17. The apparatus of claim 16, wherein the fan is configured to eject the substance in the vaporized form out of the opening at the front end portion.

18. The apparatus of claim 11, wherein the substance comprises oxalic acid.

19. The apparatus of claim 18, wherein the heating coil regulates a temperature of the oxalic acid in the container to a temperature between a predetermined threshold above 315 ° F./ 157 ° C. and another predetermined threshold below 372° F./189° C.

20. The apparatus of claim 19, further comprising a weight sensor under the container configured to indicate a weight of the oxalic acid in the container.
